(19) United States
(12) Patent Application Publication
(10) Pub. No.: US 2003/0144854 A1
(43) Pub. Date: Jul. 31, 2003

(54) Aggregate activation system

(76) Inventor: Pavel Macholda, West Linn, OR (US)

Correspondence Address: Pavel Macholda, Suite 200, 1800 Blankenship Road, West Linn, OR, 97068, US

(21) Appl. No.: 10/057,350

(22) Filed: Jan. 28, 2002

(51) Int. Cl. G06F 17/60

(52) U.S. Cl. 705/1

(57) ABSTRACT

The aggregate activation system uses keywords to activate digital or analog devices, connect licensees with each other, and authorize transfer of information or content between or among the authorized devices for the use of the licensees according to the relationship defined by the selection of activation keywords. The aggregate activation system allows the licensees to pass the licenses onto new members based on the keyword syntax, and to create clusters of licensed devices and users, according to the guidelines set by the general licenser, based on the selection of identical activation keywords.

### BACKGROUND OF THE INVENTION

1. Field of the Invention

The invention relates to the field of applications for communication devices capable of storing and processing information in a digital form, such as cellular phones, wireless personal digital assistants, network appliances and computers. The closest U.S. patent Classification Definition is described in Class 707, Subclass 104—application of distributed data structure to commercial fields.

2. Background Information

More and more people embrace communication technologies based on digital protocols, such as digital cell phones, wireless personal digital assistants, and software programs that use Internet to communicate. Many such devices are capable of executing third-party software programs. These programs need to be properly licensed for use by the licensee. The licensee has to agree to the terms and conditions, disclosure statement, and other documents that govern the use of the device or the programs that the device executes. Also, many devices and programs are designed to communicate with each other and to transmit data, voice, or video signals, together referred to as content. Mostly, content streams from the source, the publisher, to the user, the consumer. Although, more and more frequently, content may be generated by one user and sent to another user, for example, an exchange of a home-made video or music composed by the user. In such a situation, the recipient mostly uses the content without an explicit license agreement between the sender and recipient. The Aggregate Activation System deals with both situations, the provider/consumer relationship and the sender/recipient relationship within one framework of licenser/licensee. Additionally, the system defines the method of propagating the licenses through the activation of the device or the software within the device.

### BRIEF SUMMARY OF THE INVENTION

The Aggregate Activation System is a method that allows for propagating of licenses by the licensees of digital and analog media and devices and its software programs and content. For the use of individual licensees, the licenser creates one or more personal activation keyword. The licensee creates an account consisting of a user name, password, and other information deemed necessary to uniquely identify the licensee. Then, the licensee activates the device by entering the activation keyword. Providing the activation keyword is valid, the licensee's account name becomes another personal activation keyword which the licensee may further propagate. The next licensee may apply the personal activation keyword of the previous licensee to activate the device. The devices of the first and second licensees establish a connection and allow the first and second licensee to communicate information between themselves using the licensed devices. For the use of organizations, the licenser creates one or more community activation keywords. Each licensee creates an account consisting of a user name, password, and other information deemed necessary to uniquely identify the licensee. Then, the licensee activates the device by entering the community activation keyword. The licensee's device establishes connections with all the other licensees who activated their accounts using the same community activation keyword and allows the licensees to exchange information among themselves using the licensed devices. Additionally, each licensee's account name becomes a personal activation keyword that the licensee may further propagate, thus establish communication connections with the licensees who activated their devices using the personal activation keyword.

### BRIEF DESCRIPTION OF THE DRAWINGS

FIG. 1

The manufacturer or authorized re-seller of the device or software program creates a seed activation keyword, for example, “XYZ” and provides the keyword to the users who purchase or otherwise rightfully acquire the device or software. They enable their devices using the keyword ‘XYZ’. The activation process includes establishing an account name, which uniquely identifies the user. Upon successful activation of the device, the name of the account becomes the user's personal keyword, which the user may give to other users to activate their own devices or software programs. For example, user ‘BBB’ activates his device using the keyword ‘XYZ’. Then, the user ‘BBB’s device communicates its contents or software to another user, whom the user ‘BBB’ invited to activate his device using the activation keyword ‘BBB’. The new user selects a user name ‘EEE’ and goes through all the steps necessary to activate the device, and, as one of the required steps, enters the activation keyword ‘BBB’. Then, the user ‘EEE’ contacts more new users, who in turn, select user names ‘GGG’, ‘HHH’, and ‘JJJ’. All three activate their devices using the keyword provided by their host, which is in this example, ‘EEE’.

FIG. 2

Except for the seed activation keyword, the users are connected to each other according to the keyword which they used to activate the device. In this figure, users ‘AAA’ and ‘DDD’ are connected, users ‘CCC’ and ‘DDD’ are connected, and user ‘EEE’ is connected to each, ‘BBB’, ‘GGG’, ‘HHH’, and ‘JJJ’. According to the established connections, the users can exchange licensed content.

FIG. 3

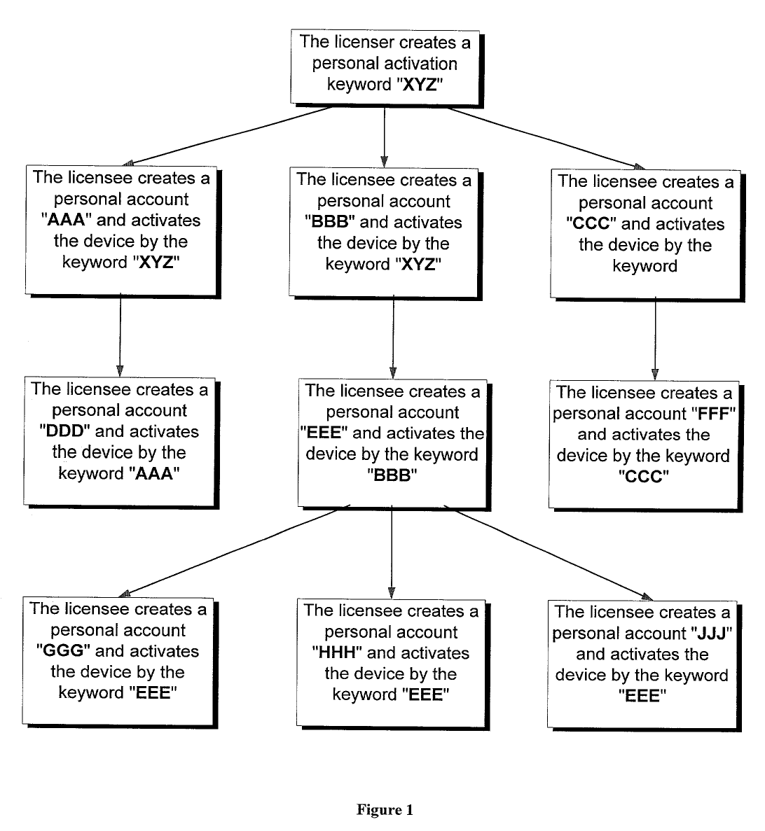

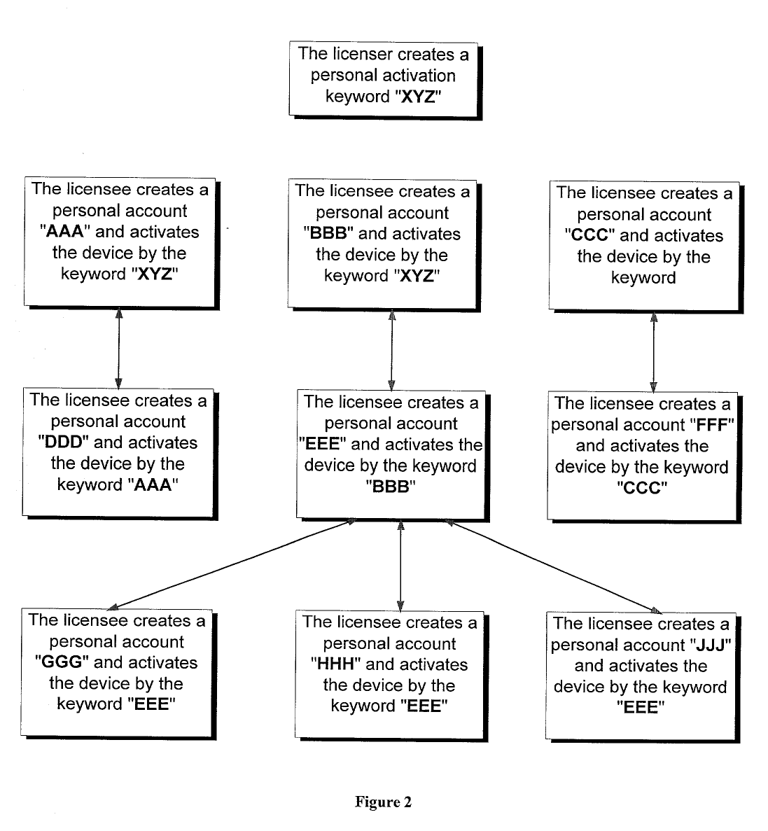

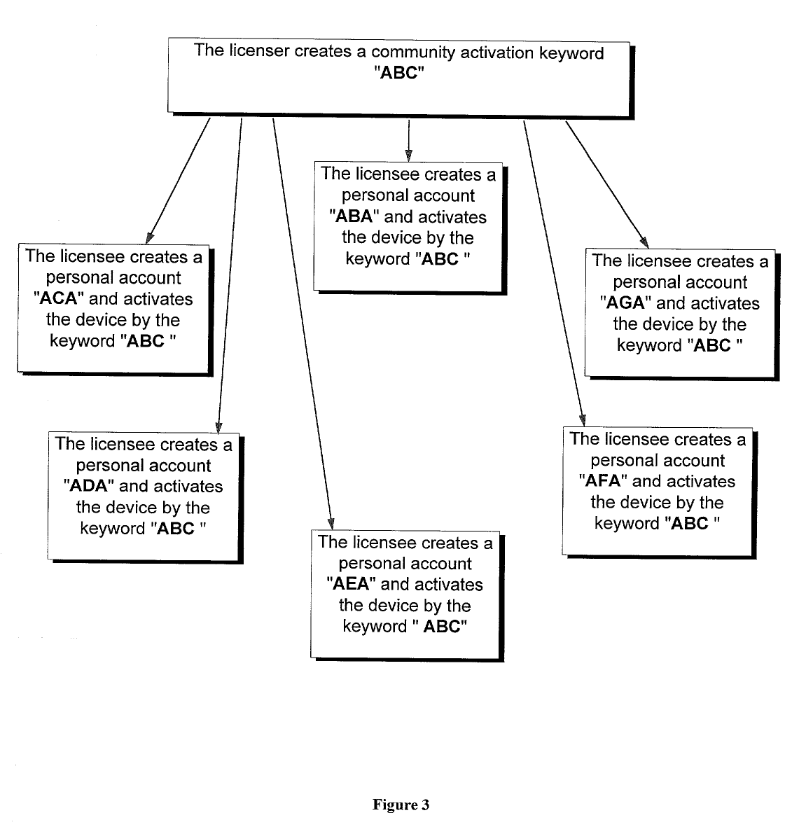

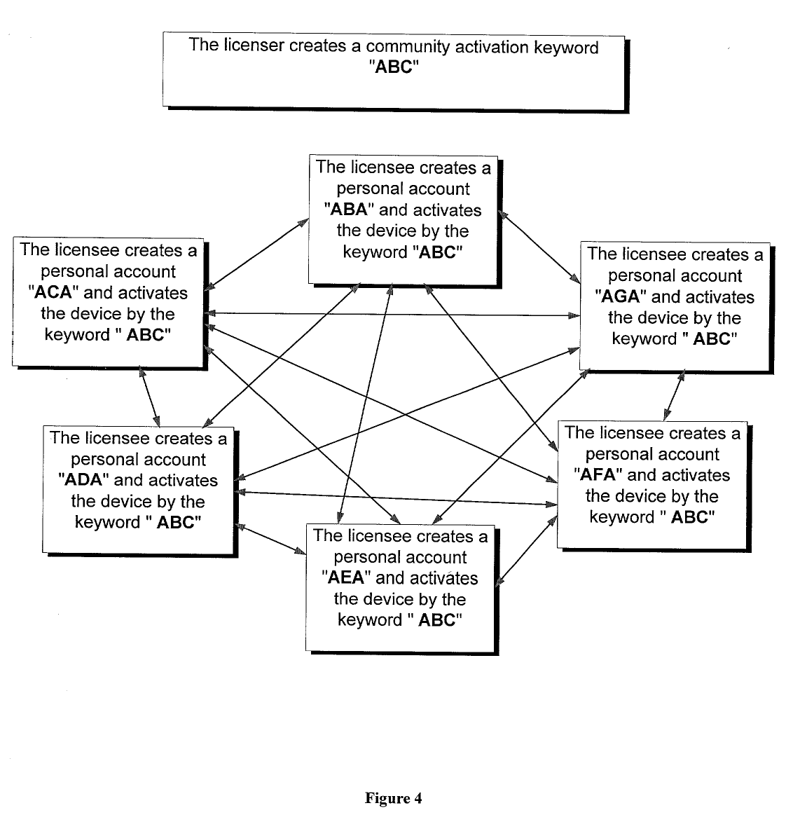

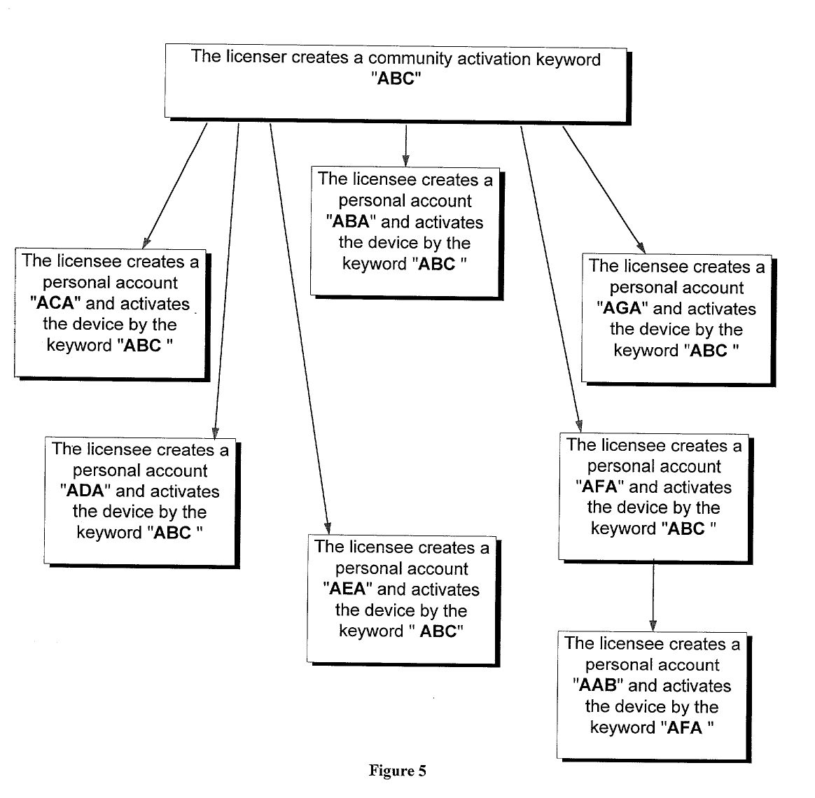

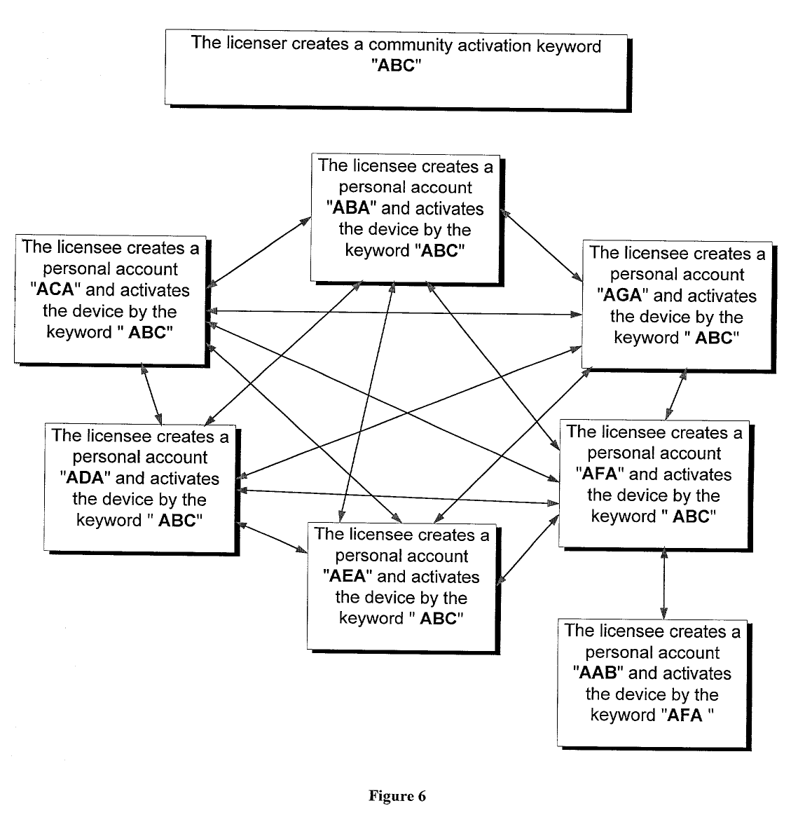

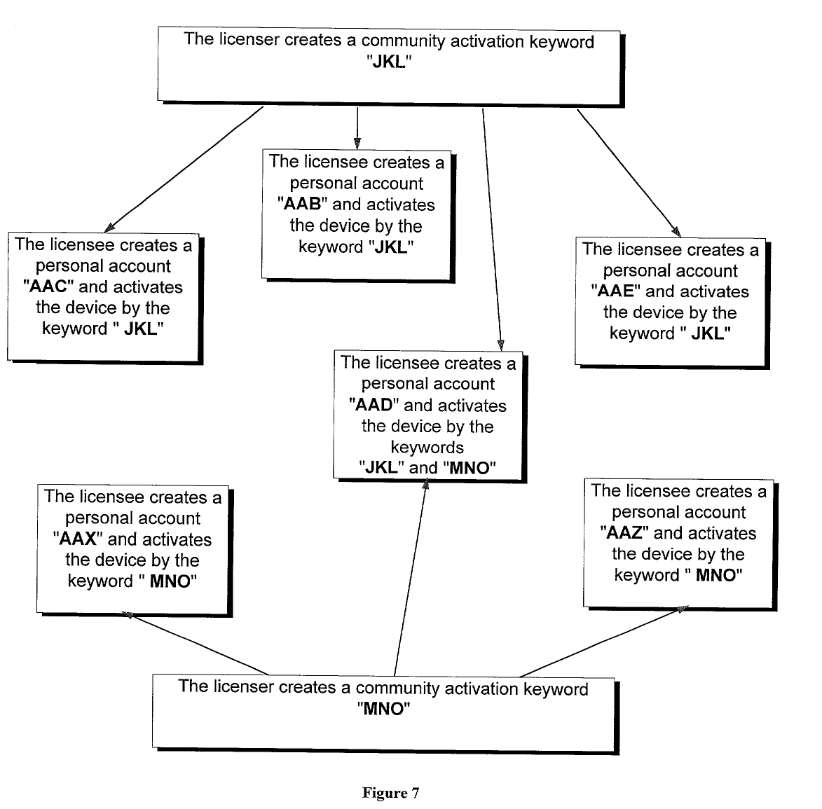

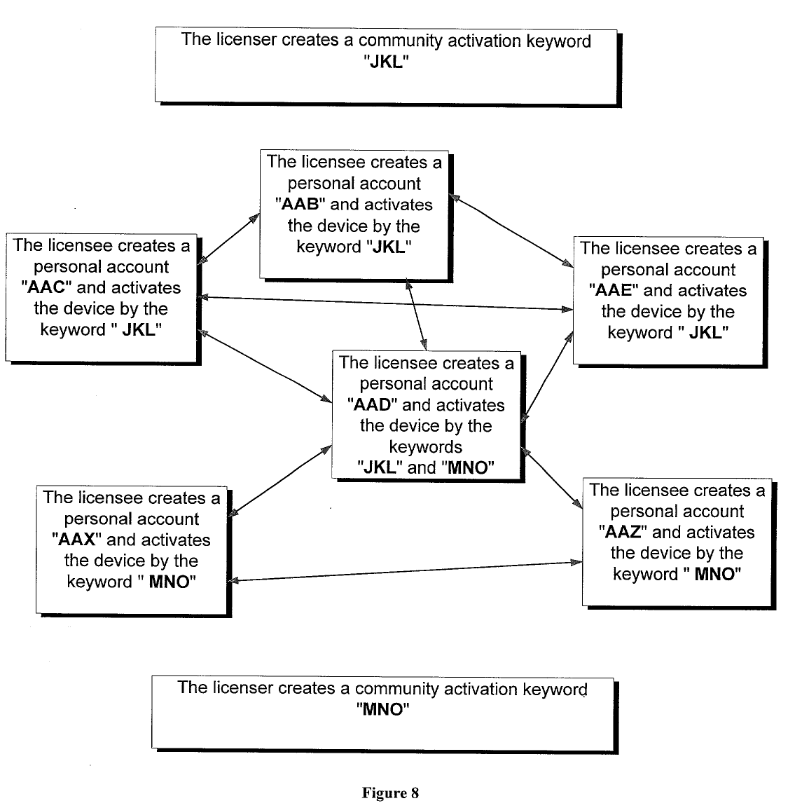

The manufacturer or authorized re-seller of the device or software program creates a community activation keyword, for example, “ABC” and provides the keyword to the users who purchase, rightfully acquire, or are otherwise authorized to use the device or software. They enable their devices using the keyword ABC. The activation process includes establishing an account name, which uniquely identifies the user. As in FIG. 1., upon successful activation of the device, the name of each account becomes the user's personal keyword, which the user may give to other users to activate their own devices or software programs.

FIG. 4

The users are connected to every other user who activated the device using the same community activation keyword. Everyone in the community can share information with all or any other member of the same community. According to the established connections, the users can exchange licensed content.

FIG. 5

Upon successful activation of the device, the name of each account becomes the user's personal keyword, which the user may give to other users to activate their own devices or software programs. For example, the user ‘AFA’ can provide the personal activation keyword ‘AFA’ to the user ‘AAB’ who activates the device using the personal activation keyword ‘AFA’.

FIG. 6

The user ‘AAB’ can exchange licensed content with user ‘AFA’, but not with the users ‘ABA’, ‘ACA’, ‘ADA’, ‘AEA’, or ‘AGA’.

FIG. 7

By activating the device multiple times, using different activation keywords, each user can access other users or communities of users. For example, the user ‘AAD’ activates the device using keywords ‘JKL’ and ‘MNO’.

FIG. 8

User ‘AAD’ can then access the licensed content of the users ‘AAB’, ‘AAC’, and ‘AAE’ as well as the content from users ‘AAX’ and ‘AAZ’. The users ‘AAB’, ‘AAC’, and ‘AAE’ can access each other's content and the users ‘AAX’ and ‘AAZ’ can access each other's content, but the users ‘AAB’, ‘AAC’, and ‘AAE’ cannot access the content of the users ‘AAX’ and ‘AAZ’ and vice versa.

### DETAILED DESCRIPTION

The Aggregate Activation System is a method of enabling communication of licensed information or content between or among users who activate their content producing and content receiving devices using activation keywords according to the license requirements set out by the general licenser. The Aggregate Activation System uses three types of keywords: seed keywords, personal keywords, and community keywords. Each device must be activated by an activation keyword, otherwise the device does not function, or its functionality is limited. Seed Keyword activates the device or software inside the device and allow a user to establish an account consisting of personal or other information and personal content or content otherwise properly authorized for distribution. The name of such an account or the user name of the holder of the account becomes a personal keyword.

Personal Keyword accomplishes the same task as the seed keyword and additionally defines the connection between the account identified by name of the personal keyword and the account of the user who activated his account using the personal keyword. The two accounts are then authorized to share content. Either account holder may later sever the connection between the two accounts either with or without impairment to the functionality of the device on either end, depending on the guidelines set by the general licenser.

Community Keyword accomplishes the same task as the personal keyword and additionally defines the connections among all the accounts activated by the same community keywords. The identified accounts are then authorized to share content. Either account holder may later sever the connection between his accounts and the rest of the community with or without detriment to the functionality of the user's device, depending on the guidelines set by the general licenser. Additionally, each user may use several activation keywords in a sequence that establishes a connection between the user and those other users who used one of the same community keywords to activate their accounts. Later, the user may sever the connection with the community by withdrawing the community keyword from his device.

What is claimed is:

1. A licensing method for digital and analog devices and software where each licensee becomes a licenser for other devices which want to communicate with the licensee.

2. A licensing method for digital and analog devices and software where each licensee becomes a global licenser for all devices which want to communicate with each other.

3. The licensing methods set forth in claims 1. and 2. which further include functions for storing, retrieving, deleting, modifying, and communicating the names of licensees and related information.

4. The licensing methods set forth in claims 1. and 2. which further include functions for verifying the validity of the conferred licenses and establishing communications through exchange of information between the devices which passed the license onto each other.

5. The licensing methods set forth in claims 1. and 2. which further include functions for verifying the validity of the conferred licenses and establishing communications through the exchange of information among the devices which derived the license from a global source.

6. The licensing methods set forth in claims 1. and 2. which further include functions for synchronizing the communication of licensed information among the licensees.

7. The licensing methods set forth in claims 1. and 2. which further include functions for viewing by the licensee parts of the information or content provided by the licenser to the licensee.

8. The licensing methods set forth in claims 1. and 2. which further include functions that allow the licenser to determine what parts of the information provided by the licenser to the licensee can each licensee access.

9. The licensing methods set forth in claims 1. and 2. which further include functions that allow the licenser to determine the identities, real or fictitious, of the licensees for the purpose of providing parts of the content set forth in claim 8.

10. The licensing methods set forth in claims 1. and 2. which further include functions that allow the licenser to become a licensee of his licensee who thus become the licenser for his licenser.

11. The licensing methods set forth in claims 1. and 2. which further include functions that allow the licenser to provide parts of the content set forth in claim 8. under the functions set forth in claim 10.

12. The licensing methods set forth in claims 1. and 2. which further uses a system of keywords to identify the relationship between or among the licensers and licensees, where a keyword may either uniquely define a connection between two users, or explicitly define connections among the users who are identified by the same keyword.
